(19) United States
(12) Patent Application Publication
(10) Pub. No.: US 2011/0027097 A1
(43) Pub. Date: Feb. 3, 2011

(54) METHOD FOR MANUFACTURING A HOLLOW BLADE

(75) Inventors: Francoise Bertrand, Bretigny sur Orge (FR); Guillaume Duclos, Moissy Cramayel (FR); Jean-Michel Patrick Maurice Franchet, Paris (FR); Olivier Michael Molinari, Avon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SNECMA, Paris (FR)

(21) Appl. No.: 12/933,997

(22) PCT Filed: Mar. 17, 2009
(86) PCT No.: PCT/FR2009/000276

§ 371 Date: Sep. 22, 2010

(30) Foreign Application Priority Data
Mar. 25, 2008 (FR) 0801598

(51) Int. Cl. F04D 29/38; B23P 15/04

(52) U.S. Cl. 416/232; 29/889.72

(57) ABSTRACT

A method for manufacturing a hollow blade for a turbomachine including drilling channels into a blank of the blade, placing inserts into the channels, forging the blank, and removing the inserts by chemical dissolution, and the blade is an aluminum alloy and the inserts are a copper alloy.

This invention relates to a method for manufacturing a hollow blade for a turbomachine.

In a turbomachine, the fixed or moving blades are intended to be placed in a circulation duct of an air flow. In order to reduce the mass of the turbomachine, it has already been proposed to use blades of composite materials. However, these materials are very expensive and the blades are technically difficult to make. Another solution consists in lightening the blade by forming therein internal recesses. For this, channels are formed in a blank of the blade then filled with inserts of a material that is different from that of the blade. A step of forging, consisting in applying a mechanical force to the blank provided with inserts, makes it possible to deform the blank in order to give it the final form of a turbomachine blade. The inserts are finally eliminated by chemical dissolution, the blades obtained as such being light as well as resistant to mechanical stresses.

The choice of the insert is particularly critical since the latter must imperatively satisfy a dual requirement concerning its mechanical properties and its chemical properties. Indeed, during the forging operation, the blank being heated in order to allow for its mechanical deformation, the melting temperature of the inserts must be greater than the forging temperature. In addition, the rheological behavior of the inserts must be sufficiently close to that of the blank, to the temperature and to the speeds of deformation under consideration, in order to obtain the form and the distribution of the internal recesses desired within the blade and to avoid either the excessive crushing of the inserts or the formation of internal cracks in the blade. Indeed, if the insert is too soft during the forging operation, the recesses filled with inserts will be crushed, and on the contrary if the insert is too hard, cracks can form within the blade at the insert/blade interface, which makes the blade fragile and limits its lifespan.

This technique can be used for the manufacture of hollow blades from titanium alloy, with steel inserts. However, these titanium alloys are expensive and their use is justified only when the blades are subjected to substantial mechanical stresses and/or high temperatures.

The invention has for object a method making it possible to manufacture hollow blades which are light and inexpensive.

For this purpose, it proposes a method for manufacturing a hollow blade for a turbomachine consisting in forming channels in a blank of the blade, in placing inserts in the channels, in subjecting the blank to a forging and in eliminating the inserts via chemical dissolution, characterized in that the blade is made of aluminum alloy and the inserts of copper alloy.

The use of aluminum in combination with the copper makes it possible, during the forging of the blade blank and of the inserts, to obtain the desired deformation since copper has a rheological behavior that is similar to that of aluminum at the temperatures required for forging the aluminum.

The copper inserts deformed by the forging operation are then dissolved by soaking in a nitric acid solution.

According to another characteristic of the invention, the blade comprises, after chemical dissolution, at least one channel formed in its thickness and extending substantially over its entire length according to the exterior profile of the blade.

According to another characteristic of the invention, the blade is covered, before elimination of the inserts, with a protective film that is resistant to the chemical dissolution, with the inserts remaining free of any protective film.

If the solution used for the chemical dissolution is provided only to eliminate the copper inserts, it is preferable to protect the aluminum alloy blade from this. For this, a wax, a varnish or an adhesive material that is resistant to the chemical agent for dissolving the inserts can be used.

According to another characteristic of the invention, the blade blank is made via aluminum flat forging, then the channels are formed in the blank by drilling of the latter.

The invention further relates to a turbomachine, such as a turboprop engine or turbojet, characterized in that it comprises hollow blades realized by executing the method described hereinabove.

The invention shall be better understood and other details, advantages and characteristics of the invention shall appear when reading the following description provided by way of a non-limiting example, in reference to the annexed drawings wherein:

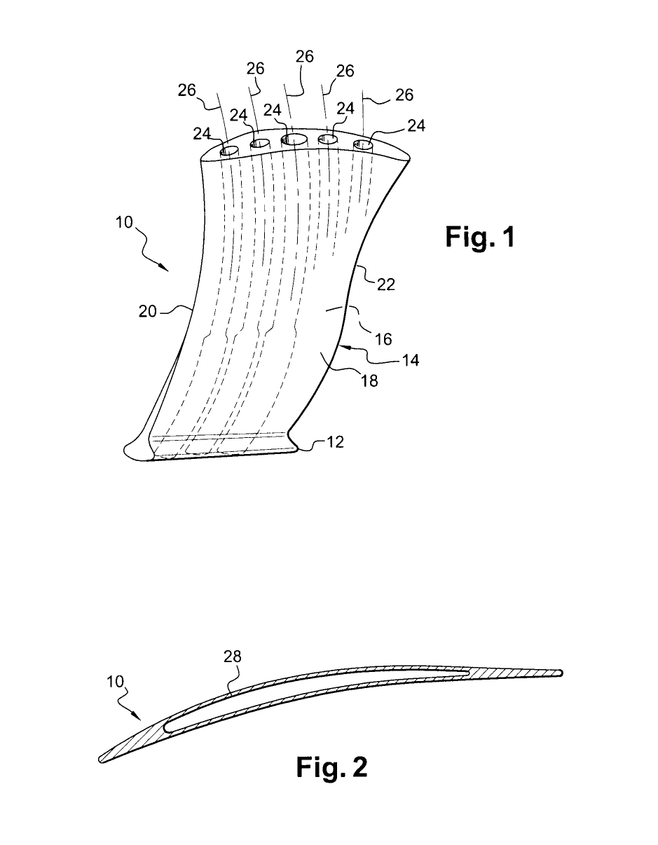

FIG. 1 is a perspective view of a hollow blade realized via forging according to the invention and having a plurality of channels;

FIG. 2 is a transversal section diagrammatical view of an alternative of the hollow blade having a single channel.

Reference is first made to FIG. 1 which shows a hollow blade 10 of a turbomachine obtained via the method according to the invention. Such a blade 10 comprises a foot 12 connected to a rotor blade 14, of which the exterior surfaces called upper surface 16 and lower surface 18 are connected by a leading edge 20 and a trailing edge 22. The foot 12 is intended to be engaged in a corresponding groove of a rotor disk (not shown) of the turbomachine while the rotor blade 14 is intended to be placed in the flow duct of a cold air flow of the turbomachine.

The method according to the invention makes it possible to realize a blade 10 such as shown in FIG. 1, which is light and resistant. For this, the method proposes to use a blade 10 made of aluminum alloy and to realize the hollow portions 24 by using copper alloy inserts.

The method consists of realizing via drilling channels in an aluminum blade blank.

For reasons of cost, the blade blank is preferentially realized via flat forging of an aluminum block. However, other techniques, such as machining, can be used to realize the blank.

Copper inserts of a form that is substantially identical to that of the channels are then introduced into the channels. The aluminum blank provided with the inserts is then heated to a temperature of approximately 400° C. and deformed by forging techniques known by those skilled in the art, in order to obtain the desired blade form 10.

During the hot deformation, the substantially similar rheological behaviors of copper and of aluminum provide the obtaining of the form and of the distribution desired of inserts within the blade 10 without anomalies at the aluminum/copper interfaces. After forging, the inserts extend along curved lines 26 corresponding to the profile of the blade 10.

The channels and the inserts initially have a straight cylindrical form with circular section, which becomes curved with elliptic section after forging.

The copper inserts are then dissolved by soaking in a nitric acid base solution. Such a solution has the advantage of preferentially dissolving the copper element in relation to the aluminum alloy and therefore only the inserts. The dissolution of the inserts can also be obtained by directing streams of nitric acid in the direction of each of the locations of the inserts.

In order to guarantee optimal protection of the blade 10, a protective film is deposited on the blade in such a way as to cover it, except at the locations corresponding to the copper inserts in order to allow for their dissolution.

The protective film can be wax or a varnish or an adhesive film, for example.

The blade obtained as such can include a plurality of recesses or channels each extending substantially along a curved central line 26, according to the profile of the blade 10 in such a way that the recesses and channels do not emerge on the upper 16 and lower 18 surfaces, or on the leading 20 and trailing 22 edges. The channels can be emerging at the radially external end of the rotor blade and as well as on the blade foot or be emerging only on the blade foot or at the radially external end of the rotor blade. The thicknesses of material surrounding the recesses are variable and are the result of a compromise between the lightening of the blade and its mechanical resistance, and are, for example, of the order of two millimeters.

The recesses or channels 24 can have a non-constant transverse section along the curved central line in order to advantageously adapt their diameter to the local thickness of the blade 10, in such a way as to obtain an optimal reduction of the mass of the blade 10. Likewise, it is possible that the sections of the channels 24 vary in a transversal direction in such a way as to have larger sections at the center of the blade 10 where the thickness is the highest and smaller sections towards the trailing edge 22 and the leading edge 20.

It is also possible to realize a single channel 28, which makes it possible to obtain a gain in mass that is even higher (FIG. 2).

Advantageously, the use of hollow blades 10 according to the invention makes it possible to reduce by approximately 20% the mass of a stage of turbomachine fixed blades.

In a particular example embodiment of the invention, the blades 10 are made of aluminum and zinc alloy and the inserts have a copper content greater than 99.90%, the chemical dissolution solution having a ratio of the volume of a 68% nitric acid solution over the volume of water between 25 and 80%. The temperature of the dissolution solution is between 20 and 60° C.

The method according to the invention can be used for moving blades as well as for fixed vanes in the various sections of a turbomachine, in particular those where cold gases or at a low temperature pass.

As such, in the case of a turbofan engine, the fixed vanes for guiding the secondary air flow circulating around the engine can be realized from hollow aluminum by using the method according to the invention.

1-6. (canceled)

7. A method for manufacturing a hollow blade for a turbomachine comprising:
forming channels in a blank of the blade;
placing inserts in the channels;
subjecting the blank to forging; and
eliminating the inserts by chemical dissolution,
wherein the blade is made from aluminum alloy and the inserts from copper alloy.

8. A method according to claim 7, wherein the chemical dissolution is realized by soaking in a nitric acid solution.

9. A method according to claim 7, wherein the blade comprises, after chemical dissolution, one or plural channels formed in its thickness and extending over its entire length according to an exterior profile of the blade.

10. A method according to claim 7, wherein the blade is covered, before eliminating the inserts, with a film that is resistant to the chemical dissolution, the inserts remaining free of any protective film.

11. A method according to claim 7, wherein the blade blank is realized via aluminum flat forging, then channels are formed in the blank by drilling the blank.

12. A turbomachine, a turboprop engine, or a turbojet, comprising hollow blades realized by execution of the method according to claim 7.
